(19) United States
(12) Patent Application Publication
(10) Pub. No.: US 2014/0282927 A1
(43) Pub. Date: Sep. 18, 2014

(54) SYSTEM AND METHOD FOR LOCATION BASED VALIDATION VIA MOBILE DEVICE

(71) Applicant: BOTTOMLINE TECHNOLOGIES (DE) INC., Portsmounth, NH (US)

(72) Inventors: Brian Smith MCLAUGHLIN, Portland, ME (US); Gareth Rory PRIEST, Newfields, NH (US); Eric CAMPBELL, Rye, NH (US)

(73) Assignee: BOTTOMLINE TECHNOLOGIES (DE) INC., Portsmouth, NH (US)

(21) Appl. No.: 13/835,630

(22) Filed: Mar. 15, 2013

(51) Int. Cl. G06F 21/31

(52) U.S. Cl. CPC G06F 21/31
USPC 726/5

(57) ABSTRACT

A system and method is presented for authenticating a user based on the location of a mobile device relative to the location of an accessing device. A user attempting to access a server with the accessing device (e.g., a desktop computer) provides credentials. After validating the credentials, the system determines a mobile device (e.g., a mobile phone) associated with the user. In order to confirm the credentials, the system determines a location of the accessing device relative to a location of the associated mobile device. If the mobile device is within a predefined proximity of the accessing device, the received credentials are confirmed and the user may be allowed access to the server. If the mobile device is not within the predefined proximity of the accessing device, the received credentials are identified as invalid and the user may be denied access to the server.

### TECHNICAL FIELD

The present invention relates to validation of user credentials and more particularly, to a system and method for validating user credentials based on the location of a mobile device associated with the user.

### BACKGROUND OF THE INVENTION

With ever increasing numbers of individuals performing sensitive actions (e.g., paying bills, viewing bank statements, etc.) on the Internet, fraud prevention has become a growing concern. In an attempt to confirm the identity of a user initiating an action, computer systems have begun to use two-factor authentication. For example, an online bank may require a user to enter a username, password, and a verification is code emailed to an email address associated with the user's account.

While two-factor authentication may help to prevent fraud, an individual who has gained access to a user's email may still overcome two-factor authentication. Thus, there exists a need for a system or method that improves user authentication.

### SUMMARY OF THE INVENTION

The present invention provides a system for authenticating a user based on the location of a mobile device associated with a user relative to the location of an accessing device.

A first aspect of the present invention relates to a method of authenticating a user. The method includes receiving, over a network, credentials of a user of an accessing device and determining a validity of the user's received credentials by comparison with saved credentials stored in a database. If the received credentials are determined valid, the method (1) determines a physical location of the accessing device relative to a physical location of a mobile device associated with the user; (2) confirms the validity of the received credentials if the physical location of the accessing device relative to the physical location of the mobile device is within a predefined proximity; and (3) identifies the credentials as unconfirmed if the physical location of the accessing device relative to the physical location of the mobile device is not within the predefined proximity. If the received credentials are determined invalid, the method identifies the credentials as invalid.

Additionally or alternatively, determining the physical location of the accessing device relative to the physical location of the mobile device includes determining the physical location of the accessing device, determining the physical location of the mobile device, and determining a distance between the physical location of the accessing device and the physical location of the mobile device.

Additionally or alternatively, the physical location of the accessing device relative to the physical location of a mobile device is within the predefined proximity if the distance between the physical location of the accessing device and the physical location of the mobile device is less than the predefined proximity.

Additionally or alternatively, the predefined proximity is a distance selected from a range of 50 yards to 5 miles.

Additionally or alternatively, the physical location of at least one of the accessing device and the mobile device is determined using a hardware location device.

Additionally or alternatively, the hardware location device comprises at least one of a global positioning system receiver, a Global Navigation Satellite System device, a Galileo positioning system device, a Compass navigation system device, and an Indian Regional Navigational Satellite System device.

Additionally or alternatively, the hardware location device is a component of at least one of the mobile device and the accessing device.

Additionally or alternatively, the physical location of at least one of the accessing device and the mobile device is determined using at least one of an IP address, cellular triangulation, multilateration of radio signals, and Wi-Fi triangulation.

Additionally or alternatively, determining a physical location of the accessing device relative to a physical location of the mobile device comprises detecting a connection between the accessing device and the mobile device.

Additionally or alternatively, the connection comprises at least one of a Bluetooth connection, a physical connection, a Wi-Fi connection, a radio frequency identification (RFID) connection, and an infrared connection.

Additionally or alternatively, an identifier of the mobile device associated with the user is stored in the database.

Additionally or alternatively, the mobile device is a mobile phone.

Another aspect of the invention relates to a system authenticating a user. The system includes a network interface and a processor. The network interface is configured to receive credentials of a user of an accessing device. The processor is configured to determine a validity of the user's received credentials by comparison with saved credentials stored in a database encoded to a non-transitory computer readable medium. If the received credentials are determined valid, the processor determines a physical location of the accessing device relative to a physical location of a mobile device associated with the user, confirms the validity of the received credentials if the physical location of the accessing device relative to the physical location of the mobile device is within a predefined proximity, and identifies the credentials as unconfirmed if the physical location of the accessing device relative to the physical location of the mobile device is not within the predefined proximity. If the received credentials are determined invalid, the processor identifies the credentials as invalid.

A further aspect of the invention relates to a server for authenticating a user. The server includes a network interface and a processor. The network interface is configured to receive credentials of a user of an accessing device. The processor is configured to validate the user's received credentials by comparison with saved credentials stored in a database encoded to a non-transitory computer readable medium. The network interface further configured to, if the received authentication credentials are valid, send a request for a physical location of the accessing device relative to a physical location of a mobile device associated with the user. The processor is further configured to, if the received credentials are valid, confirm the validity of the credentials if the physical location of the accessing device relative to the physical location of the mobile device is within a predefined proximity. The processor is also configured to, if the received credentials are valid, identify the credentials as unconfirmed if the physical location of the accessing device relative to the physical location of the mobile device is not within the predefined proximity. If the received credential are invalid, the processor identifies the credentials as invalid.

A number of features are described herein with respect to embodiments of the invention; it will be appreciated that features described with respect to a given embodiment also may be employed in connection with other embodiments.

For a better understanding of the present invention, together with other and further aspects thereof, reference is made to the following description, taken in conjunction with the accompanying drawings. The scope of the invention is set forth in the appended claims, which set forth in detail certain illustrative embodiments. These embodiments are indicative, however, of but a few of the various ways in which the principles of the invention may be employed.

### BRIEF DESCRIPTION OF THE DRAWINGS

FIG. 1 is an exemplary diagram of operation of an authentication system;

FIG. 2 is a block diagram representing the architecture of the authentication system in accordance with an exemplary embodiment of the present invention;

FIG. 3 is a flow chart representing operation of a method of authenticating a user in accordance with an exemplary embodiment of the present invention; and

FIG. 4 is a flow chart representing a particular embodiment of FIG. 3.

### DETAILED DESCRIPTION OF THE INVENTION

The present invention is now described in detail with reference to the drawings. In the drawings, each element with a reference number is similar to other elements with the same reference number independent of any letter designation following the reference number. In the text, a reference number with a specific letter designation following the reference number refers to the specific element with the number and letter designation and a reference number without a specific letter designation refers to all elements with the same reference number independent of any letter designation following the reference number in the drawings.

It should be appreciated that many of the elements discussed in this specification may be implemented in a hardware circuit(s), a processor executing software code or instructions which are encoded within computer readable media accessible to the processor, or a combination of a hardware circuit(s) and a processor or control block of an integrated circuit executing machine readable code encoded within a computer readable media. As such, the term circuit, module, server, application, or other equivalent description of an element as used throughout this specification is, unless otherwise indicated, intended to encompass a hardware circuit (whether discrete elements or an integrated circuit block), a processor or control block executing code encoded in a computer readable media, or a combination of a hardware circuit(s) and a processor and/or control block executing such code.

The present invention provides a system and method for authenticating a user based on the location of a mobile device relative to the location of an accessing device (e.g., a desktop computer). A user attempting to perform a sensitive action (e.g., access a bank account) with the accessing device provides credentials to the system. After validating the credentials (e.g., a username and password), the system determines a mobile device (e.g., a mobile phone) associated with the user. In order to confirm the credentials, the system determines a location of the accessing device relative to a location of the associated mobile device. If the mobile device is within a predefined proximity of the accessing device, the received credentials are confirmed and, e.g., the user may be allowed access to the user account, server (which may or may not be the system performing the authentication), or network. If the mobile device is not within the predefined proximity of the accessing device, the received credentials are identified as invalid and, e.g., the user may be denied access.

Turning to FIG. 1, operation of the authentication system 10 is depicted with a mobile device 24 located at four different locations, represented by mobile devices 24a-24d. The accessing device 20 provides authentication credentials to the system 10. After validating the received credentials, the system 10 attempts to confirm the validity of the received credentials. If the physical location of the accessing device 20 relative to the physical location of the mobile device 24 is within a predefined proximity 26, the system 10 confirms the received credentials. For example, for a predefined proximity 26a, of the four depicted mobile device locations, the system 10 only confirms the credentials when the mobile device 24 is positioned as depicted by mobile device 24a. That is, at the positions represented by mobile devices 24b-24d, the mobile device 24 is not within the predefined proximity 26a, and therefore, the credentials would not be confirmed. However, for a larger predefined proximity 26b, the credentials would also be confirmed if the mobile device 24 is positioned as mobile devices 24a and 24b. Similarly, for a still larger predefined proximity 26c, the mobile device 24 positioned as mobile devices 24c is also within the predefined proximity 26c.

An exemplary architecture 9 including an authentication system 10, an accessing device 20, and a mobile device 24 is depicted in FIG. 2. The system 10 may be a computer system of one or more computers or servers including at least a processor 30, a network interface 32, and computer readable medium 28. The computer readable medium 28 may include encoded thereon a database 29. The database 29 may include data structures, also referred to as tables, as described herein and may include instructions embodied on computer readable medium 28 for interfacing with the network interface 32 and for reading and writing data to the database 29.

The authentication system 10, accessing device 20, and the mobile device 24 may be communicatively coupled over a network 33, e.g., an open network (such as the Internet), a private network (such as a virtual private network), or any other suitable network. The network interface 32 of the system 10 may be configured to receive is credentials from the accessing device 20, request a physical location of the accessing device 20 relative to a physical location of the mobile device 24, and/or receive the physical location of the accessing device 20 relative to the physical location of the mobile device 24.

As will be understood by one of ordinary skill in the art, the network interface 32 may comprise a wireless network adaptor, an Ethernet network card, or any suitable device that provides an interface between the system 10 and the network 33.

The processor 30 may be configured to (1) validate the received credentials of the user, (2) determine a mobile device 24 associated with the user, and (3) confirm the validity of the received credentials if a physical location of the accessing device relative to a physical location of the mobile device is within an allowable proximity.

As will be understood by one of ordinary skill in the art, the processor 30 may have various implementations. For example, the processor 30 may include any suitable device, such as a programmable circuit, integrated circuit, memory and I/O circuits, an application specific integrated circuit, microcontroller, complex programmable logic device, other programmable circuits, or the like. The processor 30 may also include a non-transitory computer readable medium, such as random access memory (RAM), a read-only memory (ROM), an erasable programmable read-only memory (EPROM or Flash memory), or any other suitable medium. Instructions for performing the method described below may be stored in the non-transitory computer readable medium and executed by the processor 30. Based on this disclosure, one of ordinary skill in the art would understand how to program the processor 30 to perform the steps described herein.

The processor 30 may validate the credentials received by the network interface 32 by comparing the received credentials to saved credentials stored in the database 29. The saved credentials may be stored in the database 29 as plain text, encrypted text, the output of a hash function with or without salting, or in any other suitable manner. The database 29 may also store an identification of a mobile device 24 associated with each saved credential. The identification of each mobile device may is comprise a telephone number, an Internet protocol (IP) address, a media access control (MAC) address, a unique device identifier, or any other suitable means for identifying a device. The processor 30 may determine the mobile device 24 associated with a user by accessing the mobile device identifier associated with the saved credentials matching the received credentials.

As will be understood by one of ordinary skill in the art, the database 29 may describe a data structure which embodies groups of records or data elements stored in a volatile or non volatile storage medium and accessed by an application, which may be instructions coded to a storage medium and executed by a processor. The database 29 may comprise multiple individual databases stored on the same storage medium or on multiple different storage media. The system 10 may also store data in and access the database 29. While the database 29 is depicted as a component of the system 10 in FIG. 1, the database 29 could alternatively be stored on a separate server.

The processor 30 is further configured to determine a physical location of the accessing device 20 relative to a physical location of the mobile device 24. Determining the relative physical location of the accessing device 20 and the mobile device 24 may comprise determining the physical location of the accessing device 20, determining the physical location of the mobile device 24, and determining a distance between the physical location of the accessing device 20 and the physical location of the mobile device 24. Determining the physical location of the accessing device 20 and/or the mobile device 24 may comprise the system 10 requesting the accessing device 20 and the mobile device 24 for their physical location. For example, the physical location of the accessing device 20 and/or the mobile device 24 may be determined using a hardware location device 34. The hardware location device may be a component of the mobile device 24 and/or the accessing device 20.

The hardware locating device 34 may provide a longitude and latitude for the accessing device 20 or mobile device 24. For example, the hardware location device may be a global positioning system (GPS) receiver, a Global Navigation Satellite System device, a Galileo positioning system device, a Compass navigation system device, an Indian Regional Navigational Satellite System device, or any other suitable device. Upon receiving the system's request for a physical location, the accessing device 20 and/or mobile device 24 may provide the system 10 the physical location based on the output of the hardware locating device 34.

Alternatively, as opposed to a hardware locating device 34, the physical location of the accessing device 20 and the mobile device 24 may be determined using an IP address, cellular triangulation, multilateration of radio signals, Wi-Fi triangulation, or using any other suitable means.

The distance between the physical location of the accessing device 20 and the physical location of the mobile device 24 may include calculating the distance (e.g., the Euclidian distance) between the latitude and longitude coordinates of the accessing device 20 and the latitude and longitude coordinates of the mobile device 24.

If the distance between the physical location of the accessing device 20 and the physical location of the mobile device 24 is less than the predefined proximity, the processor 30 may validate the received credentials. The physical location of the accessing device 20 relative to the physical location of a mobile device 24 is within the predefined proximity if the distance between the physical location of the accessing device 20 and the physical location of the mobile device 24 is less than the predefined proximity. The predefined proximity may be a fixed distance (e.g., a distance selected from the range of 50 yards to 5 miles) or a variable distance. The predefined proximity may vary based on how the physical location of the accessing device 20 and mobile device 24 was determined. For example, if a GPS device was used to determine the position of both the accessing device 20 and the mobile device 24, the predefined distance may be 100 yards. Alternatively, if the IP address of the accessing device 20 or the mobile device 24 was used to determine the distance between the devices, the predefined distance may be 5 miles. The predefined proximity may also vary based on the location of the accessing device 20 and/or the server being accessed. For example, if the user is located in a large city where it is possible to more accurately determine physical location based on IP address, the predefined proximity may be 0.5 miles.

The predefined proximity may also vary based on the reason for requesting authentication. That is, if the user is attempting to view a utility bill, the predefined proximity may be larger than if the user is attempting to transfer money between bank accounts. Alternatively, the predefined proximity may be a user defined value or a system defined value.

As opposed to determining the physical location of the accessing device 20 and the mobile device 24, the system 10 may detect, as an indication of the relative physical location of the mobile device 24 to the accessing device 20, a connection between the accessing device 20 and the mobile device 24. That is, the system 10 may detect, e.g., a limited range connection between the accessing device 20 and the mobile device 24. For example, the connection may be a Bluetooth connection, a physical connection (e.g., a USB connection), a Wi-Fi connection, a radio frequency identification (RFID) connection, an infrared connection, or any other suitable connection. Based on the limited range of the connection, it can be assumed that, if there is a connection between the accessing device 20 and the mobile device 24, the accessing device 20 and the mobile device 24 are within a limited distance of one another. Thus, after receiving a request for the physical location, the accessing device 20 and/or the mobile device 24 may inform the system 10 that the two devices 20, 24 share a connection. Based on this information, the processor 30 may confirm the received credentials.

The accessing device 20 may comprise a personal computer, tablet computer, smart phone, e-book reader, or any other device suitable for accessing the server. As indicated previously the accessing device 20 may include a hardware locating device 32 for determining the physical location of the device 20. The accessing device 20 may additionally include hardware and/or software for communicating and interfacing with the system 10.

The mobile device 24 may comprise a cellular phone, smart phone, tablet computer, or any other suitable device. As indicated previously the mobile device 24 may include a hardware locating device 32 for determining the physical location of the device 24. The mobile device 24 may additionally include hardware and/or software for communicating and interfacing with the system 10.

Turning to FIG. 3, exemplary steps of a method for authenticating credentials are shown. The steps may be performed, e.g., in response to a request from an accessing system 20. The request may comprise, e.g., a user attempting to perform a sensitive action, such as access a bank account, make a purchase, change account settings, or access a server. In process block 112, the system 10 receives credentials of a user of the accessing device 20 over the network 33. For example, a user may be prompted to enter a user name and password after attempting to access bank account information from a bank. In process block 114, the system 10 determines a validity of the user's received credentials by comparison with saved credentials stored in a database. Determining the validity of user credentials may be performed using any suitable means known to a person of ordinary skill in the art. In decision block 116, if the credentials are invalid, the credentials are identified as invalid in process block 118. If the credentials are identified as invalid, the accessing device 20 may be denied access to the system 10 or the action the user was attempting to perform may be denied.

Alternatively, in process block 122, if the credentials are valid in decision block 116, the system 10 determines a mobile device 24 associated with the user. Determining the associated mobile device 24 may comprise accessing the database 29 to determine the mobile device identifier that is stored with the saved credentials matching the received credentials. In process block 124, the system 10 determines the physical location of the accessing device 20 relative to a physical location of the associated mobile device 24. As described previously, determining the physical location of the accessing device 20 relative to the physical location of the associated mobile device 24 may comprise detecting a connection between the accessing device 20 and the associated mobile device 24 or determining a distance between the devices 20, 24 as described in FIG. 4 below. In decision block 126, if the physical location of the accessing device 20 relative to the physical location of the mobile device 24 is within a predefined proximity, the validity of the received credentials is confirmed in process block 128. Alternatively, if the physical location of the accessing device relative to the is physical location of the mobile device is not within the predefined proximity, the credentials are identified as unconfirmed in process block 130.

Turning to FIG. 4, one embodiment of determining a physical location of the accessing device relative to a physical location of the mobile device is described. In process block 140, the system 10 determines the physical location of the accessing device 20. In process block 142, the system 10 determines the physical location of the mobile device 24. In process block 144, the system determines a distance between the physical location of the accessing device 20 and the physical location of the mobile device 24.

Although the invention has been shown and described with respect to certain exemplary embodiments, it is obvious that equivalents and modifications will occur to others skilled in the art upon the reading and understanding of the specification. It is envisioned that after reading and understanding the present invention those skilled in the art may envision other processing states, events, and processing steps to further the objectives of system of the present invention. The present invention includes all such equivalents and modifications, and is limited only by the scope of the following claims.

What is claimed is:

1. A method of authenticating a user comprising:
receiving, over a network, credentials of a user of an accessing device;
determining a validity of the user's received credentials by comparison with saved credentials stored in a database;
if the received credentials are determined valid:
determining a physical location of the accessing device relative to a physical location of a mobile device associated with the user;
confirming the validity of the received credentials if the physical location of the accessing device relative to the physical location of the mobile device is within a predefined proximity; and
identifying the credentials as unconfirmed if the physical location of the accessing device relative to the physical location of the mobile device is not within the predefined proximity; and
if the received credentials are determined invalid, identifying the credentials as invalid.

2. The method of claim 1, wherein determining the physical location of the accessing device relative to the physical location of the mobile device comprises:
determining the physical location of the accessing device;
determining the physical location of the mobile device; and
determining a distance between the physical location of the accessing device and the physical location of the mobile device.

3. The method of claim 2, wherein the physical location of the accessing device relative to the physical location of a mobile device is within the predefined proximity if the distance between the physical location of the accessing device and the physical location of the mobile device is less than the predefined proximity.

4. The method of claim 3, wherein the predefined proximity is a distance selected from a range of 50 yards to 5 miles.

5. The method of claim 3, wherein the physical location of at least one of the accessing device and the mobile device is determined using a hardware location device.

6. The method of claim 5, wherein the hardware location device comprises at least one of a global positioning system receiver, a Global Navigation Satellite System device, a Galileo positioning system device, a Compass navigation system device, and an Indian Regional Navigational Satellite System device.

7. The method of claim 5, wherein the hardware location device is a component of at least one of the mobile device and the accessing device.

8. The method of claim 3, wherein the physical location of at least one of the accessing device and the mobile device is determined using at least one of an IP address, cellular triangulation, multilateration of radio signals, and Wi-Fi triangulation.

9. The method of claim 1, wherein determining a physical location of the accessing device relative to a physical location of the mobile device comprises detecting a connection between the accessing device and the mobile device.

10. The method of claim 9, wherein the connection comprises at least one of a Bluetooth connection, a physical connection, a Wi-Fi connection, a radio frequency identification (RFID) connection, and an infrared connection.

11. The method of claim 1, wherein an identifier of the mobile device associated with the user is stored in the database.

12. The method of claim 1, wherein the mobile device is a mobile phone.

13. A system authenticating a user comprising:
a network interface configured to receive credentials of a user of an accessing device;
a processor configured to:
determine a validity of the user's received credentials by comparison with saved credentials stored in a database encoded to a non-transitory computer readable medium;
if the received credentials are determined valid:
determine a physical location of the accessing device relative to a physical location of a mobile device associated with the user;
confirm the validity of the received credentials if the physical location of the accessing device relative to the physical location of the mobile device is within a predefined proximity; and
identify the credentials as unconfirmed if the physical location of the accessing device relative to the physical location of the mobile device is not within the predefined proximity; and
if the received credentials are determined invalid, identifying the credentials as invalid.

14. A server for authenticating a user comprising:
a network interface configured to receive credentials of a user of an accessing device;
a processor configured to validate the user's received credentials by comparison with saved credentials stored in a database encoded to a non-transitory computer readable medium;
the network interface further configured to, if the received authentication credentials are valid, send a request for a physical location of the accessing device relative to a physical location of a mobile device associated with the user;
the processor further configured to:
if the received credentials are valid, confirm the validity of the credentials if the physical location of the accessing device relative to the physical location of the mobile device is within a predefined proximity;
if the received credentials are valid, identify the credentials as unconfirmed if the physical location of the accessing device relative to the physical location of the mobile device is not within the predefined proximity; and
if the received credential are invalid, identify the credentials as invalid.
